(19) United States
(12) Patent Application Publication
(10) Pub. No.: US 2014/0066248 A1
(43) Pub. Date: Mar. 6, 2014

(54) DRIVE DEVICE FOR VEHICLE WITH ELECTRIC MOTOR

(71) Applicants: Masaya Ochi, Tsukuba-shi (JP); Takashi Ito, Utsunomiya-shi (JP); Junichi Suto, Utsunomiya-shi (JP); Masaru Suzuki, Oyama-shi (JP); Kenta Komuro, Hino-shi (JP)

(72) Inventors: Masaya Ochi, Tsukuba-shi (JP); Takashi Ito, Utsunomiya-shi (JP); Junichi Suto, Utsunomiya-shi (JP); Masaru Suzuki, Oyama-shi (JP); Kenta Komuro, Hino-shi (JP)

(73) Assignee: HONDA MOTOR CO., LTD., Tokyo (JP)

(21) Appl. No.: 14/113,624

(22) PCT Filed: May 18, 2012
(86) PCT No.: PCT/JP2012/062859

§ 371 Date: Oct. 24, 2013

(30) Foreign Application Priority Data
May 23, 2011 (JP) 2011-114505
May 23, 2011 (JP) 2011-114512

(51) Int. Cl. F16C 1/02

(52) U.S. Cl. CPC F16C 1/02
USPC 475/343; 464/106

(57) ABSTRACT

The present invention relates to a drive device for a vehicle with an electric motor, for which at least a drive motor is utilized as a drive source, and the drive motor and a drive wheel are connected by means of a constant velocity universal joint. The drive device is provided with a drive motor. A drive shaft is connected to the drive motor via an inboard joint. The inboard joint is housed at the inner periphery section of the drive motor. An outer cup, a constituent of the inboard joint, is provided with a guide race on the inner periphery section in order for a roller member to slide. The outer periphery section of the outer cup is rotatably supported by the inner periphery section of the drive motor.

### TECHNICAL FIELD

The present invention relates to a drive device for use on a vehicle with an electric motor, which includes at least a drive motor as a drive source that is coupled to a drive wheel by constant velocity universal joints.

### BACKGROUND ART

Some vehicles such as automobiles or the like include a drive motor as a drive source. Actually, there are known in the art hybrid automobiles having an engine and a drive motor and vehicles with an electric motor, such as electric automobiles (or fuel-cell electric automobiles) having only a drive motor as a drive source.

Such vehicles with an electric motor are generally propelled when their drive wheels (tires) are rotated under rotational forces that are transmitted from the drive motor through constant velocity universal joints to the drive wheels.

One known technology of the kind described above is a drive mechanism for electric automobiles as disclosed in Japanese Laid-Open Patent Publication No. 04-325803, for example. As shown in FIG. 11, the drive mechanism includes a motor case 1 and a stator 3 with coils 2 wound thereon, the stator 3 being pressure-fitted in the motor case 1. The motor case 1 houses therein a cup-shaped rotor 4 of an air-core motor which rotates under magnetic forces from permanent magnets 5. A motor-side constant velocity universal joint 6 is fixed to an inner surface of the bottom of the cup-shaped rotor 4 and coupled to an end of a drive shaft 7 whose other end is connected to a tire 9 through a tire-side constant velocity universal joint 8.

The drive shaft 7 has a portion extending into the air core of the cup-shaped rotor 4. The length of the drive shaft 7 can be made more than twice the length of the drive shaft in conventional drive mechanisms.

### SUMMARY OF INVENTION

According to the above drive mechanism, the cup-shaped rotor 4 that is disposed in the motor case 1 makes it possible to provide an air-core motor. However, since the air core is included in the motor, the motor in its entity is considerably large in radial directions.

It is a general object of the present invention to provide a drive device for a vehicle with an electric motor, which does not need an air core therein.

A major object of the present invention is to provide a drive device for a vehicle with an electric motor, which is reduced in size and weight.

Another object of the present invention is to provide a drive device for a vehicle with an electric motor, which can maintain the stroke of a drive shaft.

Still another object of the present invention is to provide a drive device for a vehicle with an electric motor, which is capable of well increasing an output torque.

The present invention is concerned with a drive device for use on a vehicle with an electric motor, which includes at least a drive motor as a drive source that is coupled to a drive wheel by an inboard constant velocity universal joint, a drive shaft, and an outboard constant velocity universal joint.

According to an embodiment of the present invention, the inboard constant velocity universal joint is housed in an inner circumferential region of the drive motor, and includes an outer cup having, on an inner circumferential surface thereof, a sliding surface held in sliding contact with a joint member and having an outer circumferential surface rotatably supported on an inner circumferential surface of the drive motor.

The outer cup of the inboard constant velocity universal joint is rotatably supported on the inner circumferential surface of the drive motor. Therefore, the rotational force of the drive motor is directly transmitted to the outer cup. Therefore, the drive force is reliably and easily transmitted to the inboard constant velocity universal joint, and the drive device does not need the conventional air core and hence is reduced in size and weight.

Furthermore, the joint member of the inboard constant velocity universal joint is housed within the inner circumferential region of the drive motor, thus allowing the drive shaft to well maintain a stroke.

In the drive device, preferably, a speed reducer mechanism is housed in the inner circumferential region of the drive motor, the speed reducer mechanism reducing speed of rotation of the drive motor and transmitting the rotation to the inboard constant velocity universal joint.

According to another embodiment of the present invention, the inboard constant velocity universal joint includes an outer cup housing a joint member therein, and a shaft projecting axially outwardly from a bottom of the outer cup. The drive device further comprises a speed reducer mechanism coupled to the shaft and housed in an inner circumferential region of the drive motor.

With the above arrangement, the rotational force of the drive motor is directly transmitted to the outer cup by the speed reducer mechanism. Therefore, the drive force is reliably and easily transmitted to the inboard constant velocity universal joint.

Therefore, the drive device does not need the conventional air core and hence is reduced in size and weight. It is possible for the drive device to well increase the output torque with a speed reduction ratio set by the speed reducer mechanism.

In the drive device, the speed reducer mechanism should preferably comprise a sun gear mounted on a rotor of the drive motor, a planet gear supported on a carrier which is fixed to the shaft, an internal gear fixed to a stator of the drive motor. Preferably, the sun gear, the planet gear, and the internal gear are housed in an inner circumferential region of the rotor.

### BRIEF DESCRIPTION OF DRAWINGS

FIG. 1 is a view of a vehicle incorporating a drive device for a vehicle with an electric motor according to a first embodiment of the present invention;

FIG. 2 is a schematic cross-sectional view of the drive device;

FIG. 3 is a schematic cross-sectional view of a drive device for a vehicle with an electric motor according to a first modification of the first embodiment;

FIG. 4 is a cross-sectional view taken along line IV-IV of FIG. 3, showing a speed reducer mechanism of the drive device;

FIG. 5 is a schematic cross-sectional view of a drive device for a vehicle with an electric motor according to a second modification of the first embodiment;

FIG. 6 is a cross-sectional view taken along line VI-VI of FIG. 5, showing a speed reducer mechanism of the drive device;

FIG. 7 is a view of a vehicle incorporating a drive device for a vehicle with an electric motor according to a second embodiment of the present invention;

FIG. 8 is a schematic cross-sectional view of the drive device;

FIG. 9 is a cross-sectional view taken along line IX-IX of FIG. 8, showing a speed reducer mechanism of the drive device;

FIG. 10 is a view showing the manner in which the speed reducer mechanism operates; and

FIG. 11 is a view of a drive mechanism disclosed in Japanese Laid-Open Patent Publication No. 04-325803.

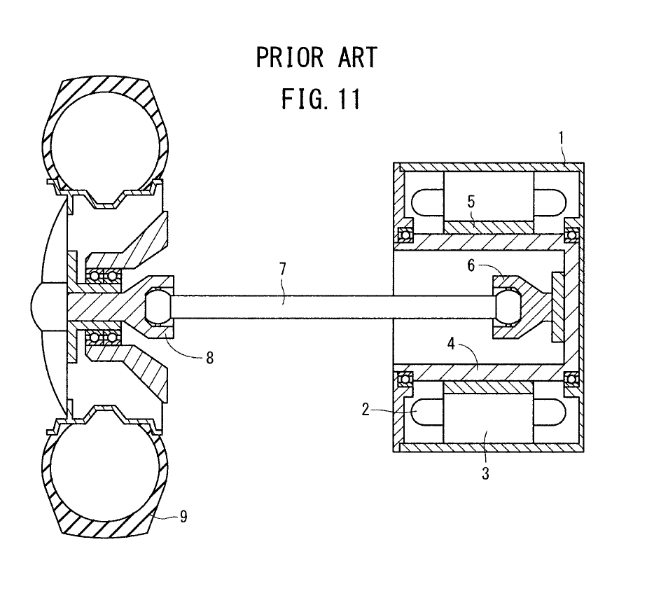

### DESCRIPTION OF EMBODIMENTS

Drive devices for a vehicle with an electric motor according to preferred embodiments of the present invention will be described in detail below with reference to the accompanying drawings.

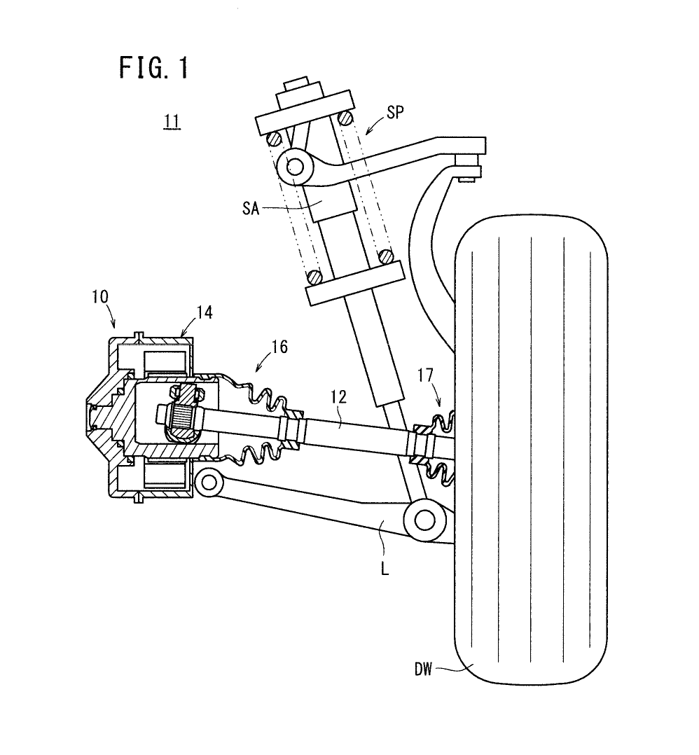

As shown in FIG. 1, a drive device 10 for a vehicle with an electric motor according to a first embodiment of the present invention is mounted on a vehicle 11 having a drive wheel DW that is coupled to the drive device 10 through a drive shaft 12.

The drive wheel DW is resiliently supported on a vehicle body by a suspension SP. The suspension SP includes a link mechanism L coupling the drive wheel DW to the vehicle body and a shock absorber SA that absorbs vibrations applied to the drive wheel DW.

An inboard joint (inboard constant velocity universal joint) 16 that is coupled to a drive motor 14 is connected to one end of the drive shaft 12. The inboard joint 16 comprises a tripod constant velocity universal joint, for example. The other end of the drive shaft 12 is connected to an outboard joint (outboard constant velocity universal joint) 17 that is coupled to the drive wheel DW.

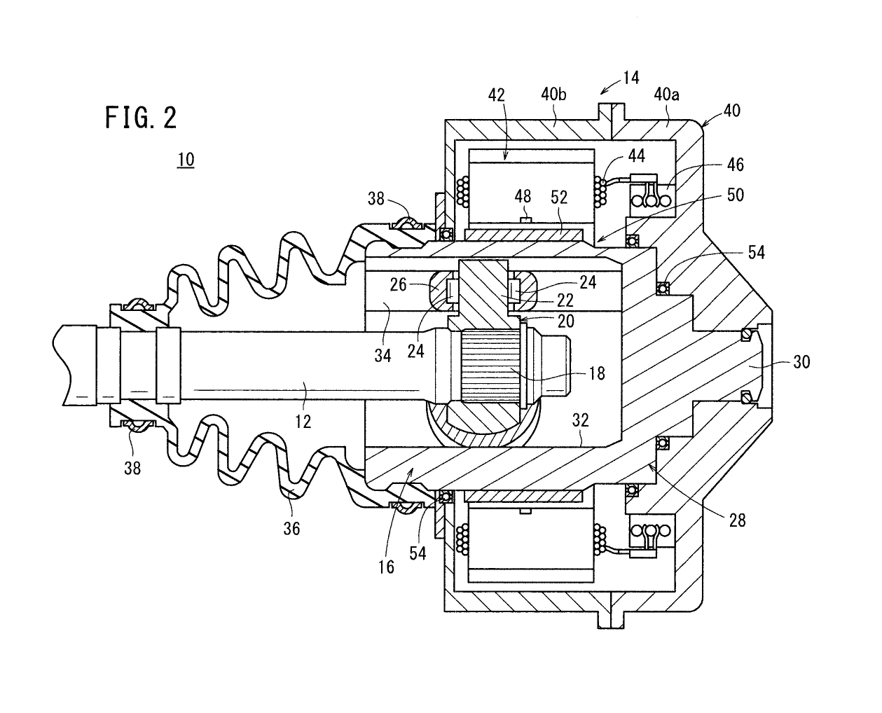

As shown in FIG. 2, the one end of the drive shaft 12 has a splined shaft 18, and the inboard joint 16 has a joint member, e.g., a spider 20, fitted over the splined shaft 18. The spider 20 has a plurality of, e.g., three, trunnions 22 integral with the outer circumferential surface thereof, the trunnions 22 being angularly spaced at predetermined angular intervals (equal angular intervals).

Ring-shaped rollers 26 are rotatably supported on the outer circumferential surfaces of the respective trunnions 22 by respective rolling members (needles, rollers, or the like) 24.

The inboard joint 16 has a bottomed hollow cylindrical outer cup 28 having a shaft 30 integral with one end (bottom end) thereof and an open opposite end.

The outer cup 28 has an inner circumferential region 32 with a plurality of, e.g., three, guide grooves 34 defined therein in which the rollers 26 are rollingly movable. The guide grooves 34 are angularly spaced at equal angular intervals and extend axially of the outer cup 28.

A boot 36 has opposite ends fastened respectively to the tip of the open end of the outer cup 28 and the drive shaft 12 by respective bands 38.

The drive motor 14 includes a motor case 40 made up of a first case member 40a and a second case member 40b. The second case member 40b houses therein a plurality of coils 44 disposed in an annular pattern, making up a stator 42. The coils 44 are connected to a drive circuit 46, and the stator 42 includes a Hall device 48 for detecting a magnetic field.

The drive motor 14 comprises a brushless motor. The Hall device 48 detects a magnetic field for the drive circuit 46 to determine timings to control and switch between S and N poles.

A rotor 50 is disposed in the stator 42. The rotor 50 includes the outer cup 28 and a plurality of permanent magnets 52 directly fixed to the outer circumferential surface of the outer cup 28. The outer cup 28 is rotatably supported in the first case member 40a and the second case member 40b by a plurality of angular bearings 54. The permanent magnets 52 are disposed in an annular pattern on the outer circumferential surface of the outer cup 28, with their S and N poles alternating with each other.

Operation of the drive device 10 thus constructed will be described below.

The drive motor 14, which comprises a brushless DC motor, has its S and N poles controlled and switched over by the drive circuit 46. The outer cup 28 is rotated under repulsive and attractive forces generated between the coils 44 and the permanent magnets 52 with the S and N poles alternating with each other on the outer circumferential surface of the outer cup 28.

The rotational force is transmitted from the outer cup 28 to the drive shaft 12 through the spider 20 with the rollers 26 held in sliding contact with the inner circumferential region 32 of the outer cup 28. The rotational force is then transmitted to the drive wheel DW that is coupled to the outboard joint 17 connected to the drive shaft 12 (see FIG. 1), thereby propelling the vehicle.

According to the first embodiment, the outer cup 28 of the inboard joint 16 is rotatably supported in an inner circumferential region of the motor case 40 of the drive motor 14 by the angular bearings 54.

The outer cup 28 with the permanent magnets 52 disposed on the outer circumferential surface thereof serves as the rotor 50. The rotational force of the drive motor 14 is directly transmitted to the outer cup 28. Therefore, the drive force (rotational force) is reliably and easily transmitted to the inboard joint 16, and the drive device 10 does not need the conventional air core and hence is reduced in size and weight.

The spider 20 as the joint member of the inboard joint 16 is housed within an inner circumferential region of the drive motor 14, thus allowing the drive shaft 12 to well maintain a stroke.

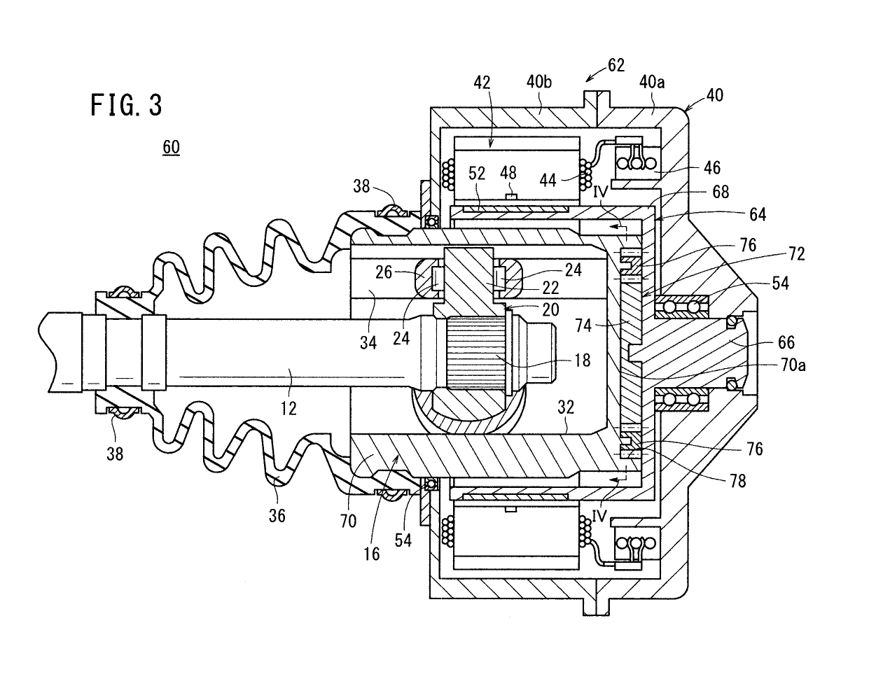

FIG. 3 is a schematic cross-sectional view of a drive device 60 for a vehicle with an electric motor according to a first modification of the first embodiment.

Those parts of the drive device 60 which are identical to those of the drive device 10 according to the first embodiment are denoted by identical reference characters, and will not be described in detail below. Similarly, those parts of a second modification of the first embodiment, to be described later, which are identical to those of the drive device 10 according to the first embodiment, will not be described in detail below.

The drive device 60 includes a drive motor 62 having a stator 42 and a rotor 64. The rotor 64 has a shaft 66 rotatably supported centrally in a motor case 40 by angular bearings 54, and a ring 68 of a relatively large diameter is integrally joined to an inner end of the shaft 66. A plurality of permanent magnets 52 are disposed in an annular pattern on the outer circumferential surface of the ring 68, with their S and N poles alternating with each other.

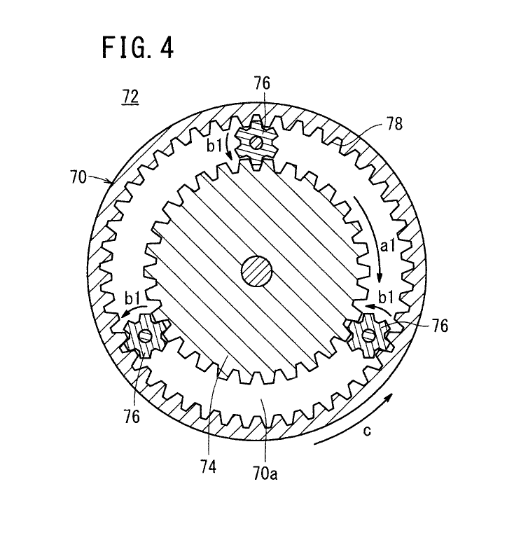

A speed reducer mechanism 72 is disposed between an outer cup 70 of an inboard joint 16 and the rotor 64. As shown in FIGS. 3 and 4, the speed reducer mechanism 72 has a sun gear 74 fixed to the rotational central axis of the rotor 64, a plurality of, e.g., three, planet gears 76 rotatably supported on an end face 70a of the outer cup 70, and an internal gear 78 having teeth on its inner circumferential region and extending in a direction perpendicular to the end face 70a of the outer cup 70. The planet gears 76 are held in mesh with the sun gear 74 and the internal gear 78.

According to the first modification, the rotor 64 rotates under a switching action of the drive circuit 46. The sun gear 74 fixed coaxially to the rotor 64 rotates in the direction indicated by the arrow a1 in FIG. 4, for example.

The planet gears 76 are held in mesh with the sun gear 74. When the sun gear 74 rotates in the direction indicated by the arrow a1, a rotational force in the direction indicated by the arrow b1 is applied to each of the planet gears 76. The planet gears 76 are also held in mesh with the internal gear 78.

The planet gears 76 are rotatably supported on the end face 70a of the outer cup 70, and the internal gear 78 is directly disposed in the outer cup 70. Therefore, the outer cup 70 rotates in the direction indicated by the arrow c in FIG. 4. The speed reducer mechanism 72 reduces the speed based on the gear ratios between the sun gear 74, the planet gears 76, and the internal gear 78.

According to the first modification, as described above, the speed reducer mechanism 72 is effectively to increase the ability to transmit the rotational force from the drive motor 62 to the inboard joint 16 and also to be able to set a torque and a rotational speed to desired levels.

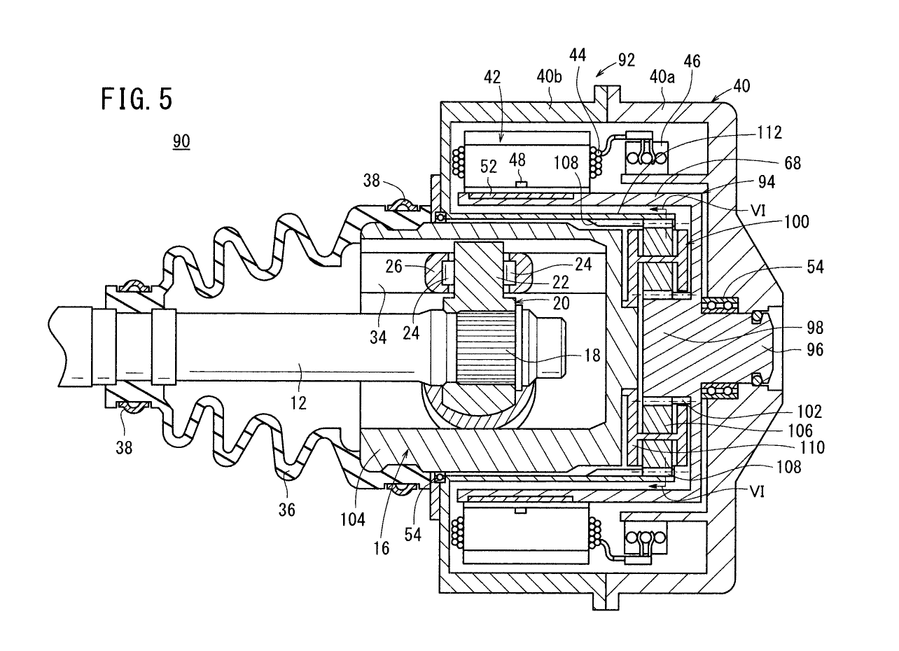

FIG. 5 is a cross-sectional view of a drive device 90 for a vehicle with an electric motor according to a second modification of the first embodiment.

The drive device 90 includes a drive motor 92 having a stator 42 and a rotor 94. The rotor 94 has a shaft 96 rotatably supported axially centrally in a motor case 40. A ring 68 and an enlarged boss 98 are integrally joined to an inner end of the shaft 96.

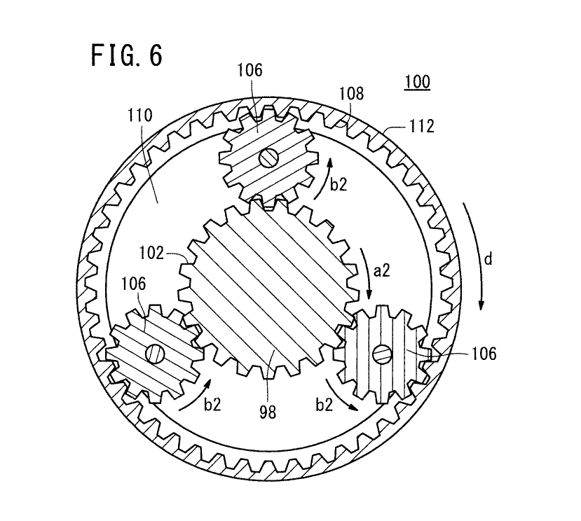

The drive device 90 includes a speed reducer mechanism 100. As shown in FIGS. 5 and 6, the speed reducer mechanism 100 has a sun gear 102 on an outer circumferential surface of the enlarged boss 98 of the rotor 94, a plurality of, e.g., three, planet gears 106 supported on an outer cup 104 of the inboard joint 16, and an internal gear 108 disposed on the motor case 40.

The planet gears 106 are rotatably mounted on a carrier 110 fixed to the tip end of the outer cup 104, and are angularly spaced at equal angular intervals. The internal gear 108 is disposed on the tip end of an inner circumferential of a hollow cylindrical member 112 that extends from an inner circumferential end of a second case member 40b into a first case member 40a.

According to the second modification, for example, the rotor 94 rotates in the direction indicated by the arrow a2 in FIG. 6 under a switching action of the drive circuit 46. The sun gear 102 on the enlarged boss 98 of the rotor 94 now rotates in the direction indicated by the arrow a2, and the planet gears 106 that are held in mesh with the sun gear 102 rotate in the direction indicated by the arrow b2.

The planet gears 106 are held in mesh with the internal gear 108 on the hollow cylindrical member 112 of the motor case 40. Therefore, when the planet gears 106 rotate in the direction indicated by the arrow b2, the outer cup 104 is caused by the carrier 110 to rotate in the direction indicated by the arrow d, which is opposite to the direction indicated by the arrow c.

According to the second embodiment, therefore, the rotation of the drive motor 92 is reduced in speed and reliably transmitted to the inboard joint 16, thereby offering the same advantages as those of the first embodiment

A second embodiment of the present invention will be described below. Those parts of the second embodiment which are identical to those of the drive device shown in FIGS. 1 through 6 are denoted by identical reference characters, and will not be described in detail below.

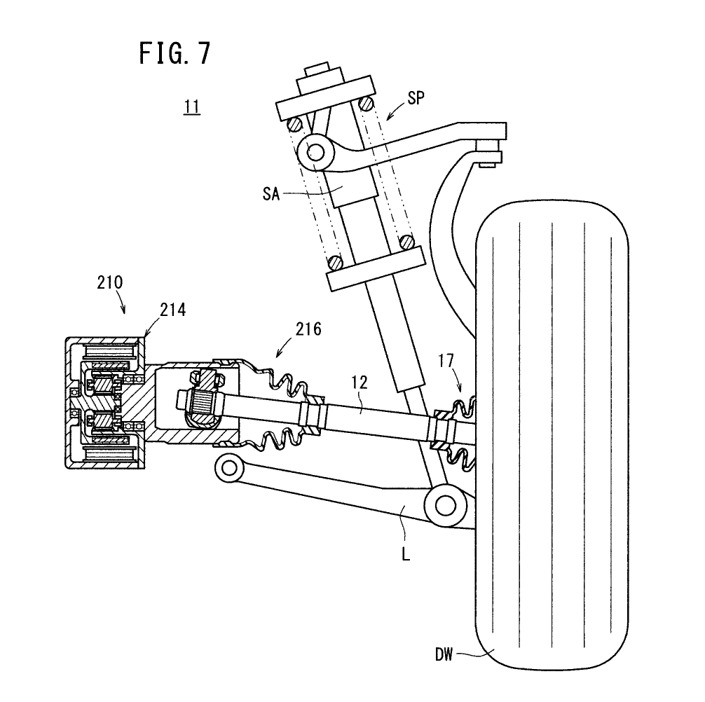

As shown in FIG. 7, a drive device 210 for a vehicle with an electric motor according to the second embodiment is mounted on a vehicle 11 having a drive wheel DW that is coupled to the drive device 210 through a drive shaft 12.

The drive wheel DW is resiliently supported on a vehicle body by a suspension SP. The suspension SP includes a link mechanism L coupling the drive wheel DW to the vehicle body and a shock absorber SA that absorbs vibrations applied to the drive wheel DW.

An inboard joint (inboard constant velocity universal joint) 216 that is coupled to a drive motor 214 is connected to one end of the drive shaft 12. The inboard joint 216 comprises a tripod constant velocity universal joint, for example. The other end of the drive shaft 12 is connected to an outboard joint (outboard constant velocity universal joint) 17 that is coupled to the drive wheel DW.

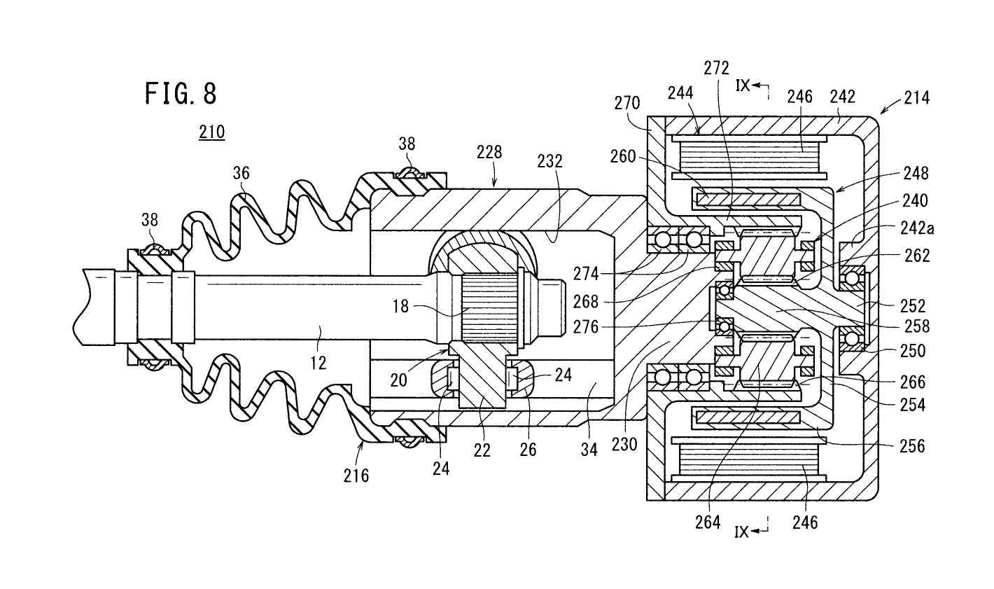

As shown in FIG. 8, the one end of the drive shaft 12 has a splined shaft 18, and the inboard joint 216 has a joint member, e.g., a spider 20, fitted over the splined shaft 18. The spider 20 has a plurality of, e.g., three, trunnions 22 integral with the outer circumferential surface thereof, the trunnions 22 being angularly spaced at predetermined angular intervals (equal angular intervals). The inboard joint 216 may comprise any of various conventional constant velocity universal joints.

Ring-shaped rollers 26 are rotatably supported on the outer circumferential surfaces of the respective trunnions 22 by respective rolling members (needles, rollers, or the like) 24.

The inboard joint 216 has a bottomed hollow cylindrical outer cup 228 having a shaft 230 integrally projecting axially outwardly from a bottom (one end) thereof and an open opposite end.

The outer cup 228 has an inner circumferential region 232 with a plurality of, e.g., three, guide grooves 34 defined therein in which the rollers 26 are rollingly movable. The guide grooves 34 are angularly spaced at equal angular intervals and extend axially of the outer cup 228.

A boot 36 has opposite ends fastened respectively to the tip of the open end of the outer cup 228 and the drive shaft 12 by respective bands 38.

The drive device 210 includes a speed reducer mechanism 240 coupled to the shaft 230 of the outer cup 228 and housed in an inner circumferential region of the drive motor 214. The drive motor 214 has a motor case 242 having a bottomed hollow cylindrical shape. The motor case 242 includes a disk-shaped bottom 242a on one end thereof.

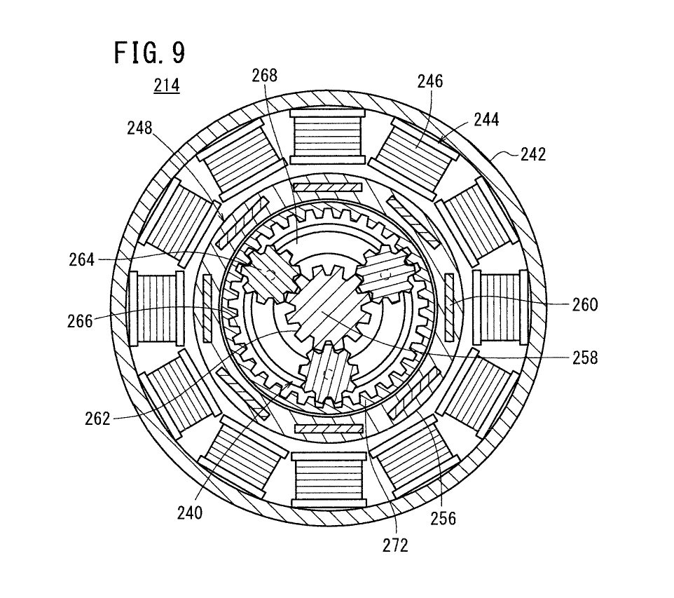

As shown in FIGS. 8 and 9, the motor case 242 houses therein a plurality of coils 246 disposed in an annular pattern, making up a stator 244. The coils 246 are connected to a drive circuit, not shown. The drive motor 214 comprises a brushless DC motor, for example.

A rotor 248 is disposed in an inner circumferential region of the stator 244. As shown in FIG. 8, the rotor 248 has a shaft 252 rotatably supported centrally in the bottom 242a of the motor case 242 by a bearing 250. The shaft 252 has an integral ring 256 of a relatively large diameter joined thereto through a disk 254. An enlarged boss 258 is disposed inwardly of the shaft 252 and integrally coupled coaxially therewith.

The ring 256 accommodates therein a plurality of permanent magnets 260 disposed in an annular pattern with their S and N poles alternating with each other. The rotor 248 may comprise a laminated assembly of magnetic steel sheets, rather than the permanent magnets 260.

The speed reducer mechanism 240 has a sun gear 262 on an outer circumferential surface of the enlarged boss 258 of the rotor 248, a plurality of, e.g., three, planet gears 264 supported on the outer cup 228 of the inboard joint 216, and an internal gear 266 disposed on the motor case 242. In the speed reducer mechanism 240, the sun gear 262, the planet gears 264, and the internal gear 266 are housed in an inner circumferential region of the rotor 248.

The planet gears 264 are rotatably mounted on a carrier 268 fixed to the tip end of the shaft 230 of the outer cup 228, and are angularly spaced at equal angular intervals (see FIGS. 8 and 9). As shown in FIG. 8, a disk 270 has a radially outer end integrally or separately joined to an open end of the motor case 242 and a radially inner end that is integrally joined to a tubular member 272. The internal gear 266 is disposed on an inner circumferential surface of the tubular member 272.

The shaft 230 of the outer cup 228 is rotatably supported in the motor case 242 by bearings 274 disposed between the shaft 230 and the tubular member 272. The enlarged boss 258 of the rotor 248 is relatively rotatably held in engagement with the tip end of the shaft 230.

Operation of the drive device 210 thus constructed will be described below.

When an electric current flows through the coils 246 of the stator 244, they generate electromagnetic forces in the drive motor 214. The rotor 248 including the ring 256 is rotated under repulsive and attractive forces generated between the coils 246 and the permanent magnets 260 with the S and N poles alternating with each other on the ring 256.

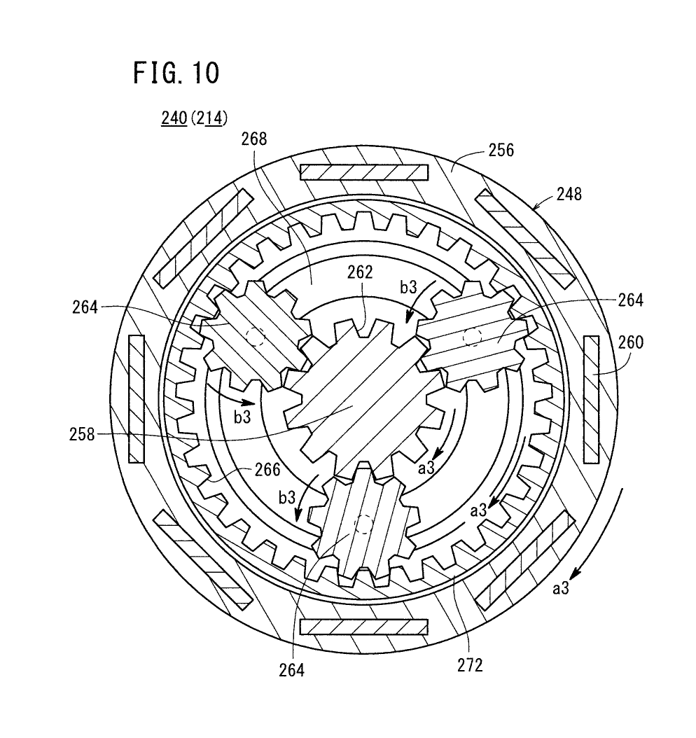

As shown in FIG. 10, when the rotor 248 rotates in the direction indicated by the arrow a3, for example, the sun gear 262 on the enlarged boss 258 of the rotor 248 rotates in unison with the rotor 248 in the direction indicated by the arrow a3.

The planet gears 264 are held in mesh with the sun gear 262. When the sun gear 262 rotates in the direction indicated by the arrow a3, a rotational force in the direction indicated by the arrow b3 is applied to each of the planet gears 264. The planet gears 264 are also held in mesh with the internal gear 266. The internal gear 266 is disposed on the inner circumferential surface of the tubular member 272 fixed to or integral with the motor case 242.

When the planet gears 264 rotate in the direction indicated by the arrow b3, therefore, the outer cup 228 is caused by the carrier 268 to rotate in the direction indicated by the arrow a3. The speed reducer mechanism 240 reduces the speed based on the gear ratios between the sun gear 262, the planet gears 264, and the internal gear 266.

The rotational force is transmitted from the outer cup 228 to the drive shaft 12 through the spider 20 with the rollers 26 held in sliding contact with the inner circumferential region 232 of the outer cup 228. The rotational force is then transmitted to the drive wheel DW that is coupled to the outboard joint 17 connected to the drive shaft 12 (see FIG. 7), thereby propelling the vehicle.

According to the second embodiment, as shown in FIG. 8, the speed reducer mechanism 240 is coupled to the shaft 230 that projects axially outwardly from the bottom of the outer cup 228 of the inboard joint 216, and housed in an inner circumferential region of the drive motor 214. Consequently, the rotational force from the drive motor 214 is directly transmitted through the speed reducer mechanism 240 to the outer cup 228, so that the drive force can reliably and easily be transmitted to the inboard joint 216.

Therefore, the drive device 210 does not need the conventional air core and hence is reduced in size and weight. It is possible for the drive device 210 to well increase the output torque with a speed reduction ratio set by the speed reducer mechanism 240.

1. A drive device for use on a vehicle with an electric motor, which includes at least a drive motor as a drive source that is coupled to a drive wheel by an inboard constant velocity universal joint, a drive shaft, and an outboard constant velocity universal joint, wherein
the inboard constant velocity universal joint includes an outer cup having, on an inner circumferential region thereof, a sliding surface held in sliding contact with a joint member; and
the outer cup has an outer circumferential region rotatably supported on an inner circumferential region of the drive motor, thereby the inboard constant velocity universal joint being housed in the inner circumferential region of the drive motor.

2. The drive device for use on the vehicle with the electric motor according to claim 1, wherein a speed reducer mechanism is housed in the inner circumferential region of the drive motor, the speed reducer mechanism reducing speed of rotation of the drive motor and transmitting the rotation to the inboard constant velocity universal joint.

3. The drive device for use on the vehicle with the electric motor according to claim 2, wherein the speed reducer mechanism comprises:
a sun gear mounted on a rotor of the drive motor;
a planet gear rotatably supported on the outer cup and held in mesh with the sun gear; and
an internal gear having teeth held in mesh with the planet gear, the teeth extending in a direction perpendicular to a bottom of the outer cup.

4. The drive device for use on the vehicle with the electric motor according to claim 2, wherein the speed reducer mechanism comprises:
a sun gear mounted on a rotor of the drive motor;
a planet gear rotatably supported on the outer cup and held in mesh with the sun gear; and
an internal gear disposed on a case which houses the drive motor therein and held in mesh with the planet gear.

5. A drive device for use on a vehicle with an electric motor, which includes at least a drive motor as a drive source that is coupled to a drive wheel by an inboard constant velocity universal joint, a drive shaft, and an outboard constant velocity universal joint, wherein
the inboard constant velocity universal joint includes an outer cup housing a joint member therein, and a shaft projecting axially outwardly from a bottom of the outer cup; and
the drive device further comprises:
a speed reducer mechanism coupled to the shaft and housed in an inner circumferential region of the drive motor.

6. The drive device for use on the vehicle with the electric motor according to claim 5, wherein the speed reducer mechanism comprises:
a sun gear mounted on a rotor of the drive motor;
a planet gear supported on a carrier which is fixed to the shaft, and held in mesh with the sun gear; and
an internal gear fixed to a stator of the drive motor and held in mesh with the planet gear, wherein
the sun gear, the planet gear, and the internal gear are housed in an inner circumferential region of the rotor.
